(19) United States
(12) Patent Application Publication
(10) Pub. No.: US 2009/0135408 A1
(43) Pub. Date: May 28, 2009

(54) Method for reducing the uncertainty of the measured average PMD of a long fiber

(76) Inventors: Mikhail Brodsky, Millburn, NJ (US); Mikhail Boroditsky, South Amboy, NJ (US); Peter David Magill, Freehold, NJ (US)

Correspondence Address: AT& T LEGAL DEPARTMENT - Monka;ATTN: PATENT DOCKETING, ROOM 2A - 207, ONE AT & T WAY, BEDMINSTER, NJ, 07921, US

(21) Appl. No.: 12/154,865

(22) Filed: May 28, 2008

Related U.S. Application Data
(60) Provisional application No. 61/004,447, filed on Nov. 27, 2007.

(51) Int. Cl. G01N 21/00

(52) U.S. Cl. 356/73.1

(57) ABSTRACT

A methodology, device and memory medium for measuring the polarization mode dispersion (PMD) of an optical fiber is disclosed. The root mean square (rms) differential group delay (DGD) of fiber sections is estimated, the multisection DGD value τ_{Σ} is calculated, and a determination is made as to how much the value τ_{Σ} is likely to differ from the true mulitsection rms value τ_{Σ}^{rms}.

### CLAIM OF PRIORITY

This application claims priority to, and incorporates by reference herein in its entirety, pending U.S. Provisional Patent Application Ser. No. 61/004,447, filed Nov. 27, 2007, entitled “Method for Reducing the Uncertainty of the Measured Average PMD of a Long Fiber.”

### FIELD OF THE INVENTION

The present invention relates generally to optical communications, and more particularly, to a system and method for optimally measuring the root-mean-square average Polarization Mode Dispersion (PMD) in optical transmission media.

### BACKGROUND OF THE INVENTION

Optical communications have revolutionized the telecommunications industry in recent years. The fiber optic medium provides the ability to efficiently transmit high bit rate signals through a low-loss medium. The development of modern high bandwidth techniques, and wavelength division multiplexing (WDM) to permit the simultaneous transmission of multiple high bandwidth channels on respective wavelengths, has enabled a tremendous increase in communications capacity. The last decade has been seen efforts to increase capacity by taking advantage of the fiber optic medium to the maximum extent possible.

Signals transmitted through an optical medium can be affected by PMD, which is a form of signal distortion that can be caused by subtle physical imperfections in the optical fiber. In principle, an optical fiber with a circular core has rotational symmetry, so that there is no preferred direction for the polarization of the light carrying the optical signal. However, during fabrication, jacketing, cabling, and installation, perturbations in the fiber that will distort this symmetry can occur, thereby causing the fiber to “look different” to various optical polarizations. One of the manifestations of this loss of symmetry is “birefringence,” or a difference in the index of refraction for light that depends on the light's polarization. Light signals with different polarization states will travel at different velocities. In particular, there will be two states of polarization (SOPs), referred to as the “eigenstates” of polarization corresponding to the asymmetric fiber. These eigenstates form a basis set in a vector space that spans the possible SOPs, and light in these eigenstates travels at different velocities.

A birefringent optical fiber transporting a modulated optical signal can temporally disperse the resulting optical frequencies of the signal. For example, an optical pulse, with a given optical polarization, can be formed to represent a “1” in a digital transmission system. If the signal is communicated through a medium with uniform birefringence (i.e., remaining constant along the length of the fiber), the SOPs can be de-composed into corresponding eigenstates, thereby forming two independent pulses, each traveling at its own particular velocity. The two pulses, each a replica of the original pulse, will thus arrive at different times at the end of the birefringent fiber. This can lead to distortions in the received signal at the end terminal of the system. In this simple illustrative case, the temporal displacement of the two replicas, traveling in the “fast” and “slow” SOPs, grows linearly with distance.

In a typical optical communications system, birefringence is not constant but varies randomly over the length of the transmission medium. Thus, the birefringence, and therefore, the eigenstate, changes with position as the light propagates through the length of the fiber. In addition to intrinsic changes in birefringence resulting from imperfections in the fabrication processes, environmental effects such as, for example, temperature, pressure, vibration, bending, etc., can also affect PMD. These effects can likewise vary along the length of the fiber and can cause additional changes to the birefringence. Thus, light that is in the “fast” SOP in one section of fiber might become be in the “slow” SOP at another section of the fiber. Instead of increasing linearly with distance, the temporal separations in the pulse replicas eventually take on the characteristics of a random walk, and grow with the square root of the distance. Despite the local variations in the fast and slow states, it is understood that when the fiber as a whole is considered, another set of states can be defined that characterize the PMD for the entire fiber and split the propagation of the signal into fast and slow components. These “principal states” can be imaged (in a mathematical sense) back to the input face, and used as an alternative basis set. Thus, an arbitrary launch SOP will have components in each of the principal states, and distortion will result from the replication of the pulses after resolution into principal states and their differential arrival times. While the physical process is described in the foregoing in a “global” as opposed to “local” sense, the basic impairment is the same; distortion results from the time delay introduced in the pulse replicas.

The above discussion relates to “narrowband” signals, i.e., having a narrow enough bandwidth that the optical properties of the fiber can be characterized as operating at a single wavelength. This is commonly referred to as “first order PMD.” Birefringence, however, can also vary with wavelength, such that each section of fiber may have slightly different characteristics, both in the magnitude and direction of the birefringence. As a consequence, after a long propagation through an optical medium, light from two neighboring wavelengths initially having the same polarization may experience what looks like a fiber with two different characteristics.

Theoretically, PMD can be represented by a Poincare sphere, or “Stokes' space” representation. In this representation, the equations of motion for SOPs and PMD at a given optical frequency are given by:

∂s/∂z=β×s (1a)

∂s/∂ω=τ×s (1b)

∂τ/∂z=∂β/∂ω+β×τ (1c)

In these equations (which are in the “representation” space, not “real” space) “β” represents the birefringence of the fiber at position z, “s” represents the SOP of the light at position z, and “τ” represents the PMD. Generally, Eqn. (1a) states that birefringence causes the representation of the SOP to rotate about the β axis as light propagates through the fiber. Eqn. (1b) states that, when viewed at a given position (e.g., the fiber output), the system's PMD causes the SOP to rotate about it as a function of optical frequency. In this regard, light launched at a given optical frequency will evolve to an SOP at the output, and if the optical frequency is then changed (but the launch polarization remains the same), the SOP at the output will also begin to rotate about the PMD vector, τ. Eqn (1c) states that the vector characterizing PMD changes along the length of the fiber. The driving term in Eqn (1c), β′=∂β/∂ω, which we refer to as the “specific PMD,” describes the relationship of birefringence to optical frequency. Even for the simplest cases, there is usually a non-zero driving term (and thus PMD) for birefringent fibers. Based on the above, the vector s will suffer infinitesimal rotations about the axis defined by β, and that the rotation axis will change as β changes with distance (and parametrically with time). However, the total evolution of s can be represented by a single, finite rotation based upon Euler's theorem. If the signal bandwidth is large enough to experience these variations, it is commonly referred to as “higher order” PMD. Higher order PMD also leads to pulse distortion as the optical bandwidth of the signal increases. As the bandwidth increases, the input signal can be decomposed into Fourier components, with each propagated in accordance with the equations discussed above, and the components collected at the output. In the narrowband context, for illustrative purposes, the “concatenation rule” represented by the above equations states that the PMD of a given section of fiber can be “imaged” to the PMD at the output through the same transformation that governs birefringence. For a fiber consisting of two sections having respective PMDs τ₁ and τ₂, and respective rotations of the SOP via finite rotations R₁ and R₂, the total PMD can be represented by:

τ=τ₂+R₂τ₁ (2)

This equation states that the final PMD vector is represented by the vectorial sum of the second (i.e. final) section's PMD vector and the first section's PMD vector, but only after that first PMD vector has been rotated by the same rotation operator (R₂) that rotates the SOPs propagating at that wavelength. This is shown by noting the rotations by β implied in Eqns. 1a and 1c.

A generalization of Eqn. 2 shows that a similar rule applies for a fiber having multiple sections. Thus, each section of length Δz can be considered as having it's own uniform primitive PMD vector, β′Δz. The PMD of the entire multi-sectioned fiber can be characterized as a vector sum of the transformed primitive PMDs, one for each section, where each PMD primitive vector is transformed by the concatenated rotation of all the sections between it and the output. Since each of these constituent vectors is only a transformed version of its corresponding primitive PMD vector, each has the same length as its primitive vector, but effectively suffers a random rotation (the Euler's theorem equivalent of the concatenated rotations between the section and the output). This process is illustrated in FIG. 1, where for an arbitrary optical frequency ω₀, the fiber (hereinafter, the optical fiber will be referred to as optical fiber) 100 is segregated into five independent sections (i.e., A, B, C, D, E), where each section's PMD is represented by a vector (row 102) directly below that section, and these PMD vectors represent a random distribution in magnitude and direction for the respective sections of the optical fiber. Each section's PMD vector (except the last one's) is imaged to the end and is shown on the right side of the figure (at 106) as a primed version of the original. Thus, the PMD vector for section B is propagated through sections C, D, and E, resulting in its output image, vector B′. The PMD for the entire fiber is then computed as the vector sum of these constituents as depicted at 108 in FIG. 1.

Referring now to FIG. 2, the PMD of the same fiber is shown at a slightly different optical frequency, ω₀+Δω. In this example, in row 202 the PMD for each section at ω₀ (from FIG. 1) is represented by dotted vectors, while the PMD for each section at ω₀+Δω is represented by solid vectors. Each primitive vector corresponding to this neighboring frequency (ω₀+Δω) is slightly different than the primitive vector for the original frequency ω₀. This, by itself, results in a slightly different sum for the total PMD vector at ω₀+Δω. However, in addition to slight changes in the primitive vectors, the new optical frequency also causes different rotations in each section, since the birefringence in each section can also be a function of optical frequency. The images for each section are imaged (trajectories 204) to the output at 206, and are slightly different from those depicted in FIG. 1 as shown by the difference at 206 between the solid and dotted arrows. These change more dramatically as the optical frequency changes. In FIG. 2, the total PMD vector 208 at this new optical frequency is shown as a solid arrow, while the PMD vector at ω₀ (from FIG. 1) is depicted as a dotted arrow. Thus, the PMD will change in magnitude and direction as a function of the optical frequency, even though the constituent PMD vectors for the sections may be drawn from the same statistical ensemble representing the fiber's properties. In large part, the study of PMD is a study of the properties of the statistics of the vector sum of these images.

Both the magnitude of the PMD vector, called the “differential group delay” or DGD, and the directions of the unit vectors parallel and anti-parallel to the PMD vector, called the “Principal States of Polarization” (PSPs), change with optical frequency. The principal states are orthogonal and thus are on opposite sides of the sphere. The unit vector is usually associated with the slowest mode. Most frequently, it is the DGD which is plotted in discussions of PMD, but variations in the PSPs with optical frequency also can cause distortion in the optical link. The properties of the PMD are therefore going to follow the statistics of the sum of a set of vectors from the sections of the fiber that are chosen from a distribution and then, for the most part, randomly rotated after propagation through the fiber before being summed.

As discussed above, PMD fluctuates with changes in environmental conditions. Even small environmental changes can add perturbations to the birefringence of sections of the fiber and thereby move many of the imaged primitive vectors. This will consequently change the vector sum. It is to be expected that, at least for subtle environmental changes, the major effect is randomization of the individual rotations in each of the sections. However, since the original distribution was already random, the statistical properties of the perturbed fiber are expected to be essentially the same as those of the original fiber.

In FIG. 4, there is depicted a block diagram of an illustrative optical transmission system 400, comprising an optical source 402, polarization rotator 404 and an optical receiver 406. The polarization rotator (or polarization scrambler) 404 receives optical signals from the optical source 402 via a first section 408 of an optical fiber, rotates the polarization states of the optical signals, and then provides the rotated optical signals to the optical receiver 406 via a second section 410 of the optical fiber. The polarization rotator rotates the polarization states of the optical signals received via link 408 as described in U.S. Pat. No. 6,961,483 (“The '483 Patent”), assigned to the assignee of the present application, and the disclosure of which is incorporated by reference herein. The optical source 402 and the optical receiver 406 may be any one of a plurality of different types of optical sources and receiving devices, such as transmission systems with optical transceivers or any known or later developed combination of software and hardware capable of generating and receiving, relaying and/or recalling from storage any information capable of being transmitted and received in an optical signal.

The average PMD of an optical fiber is typically characterized by the root-mean-square (rms) differential group delay (DGD), τᵣₘₛ, which is averaged over an infinitely large optical frequency range. However, using real-world instruments with finite frequency ranges, τᵣₘₛ cannot be measured precisely for recent-vintage low-PMD fibers. Thus, τᵣₘₛ is approximated by τ^{B}, the rms DGD averaged over a finite bandwidth B, which is a random variable with a relatively large standard deviation. For example, using typical commercial light sources having a spectrum of no more than 100 nm, a measured rms DGD value τ^{B} of 0.2 ps (which corresponds to a 100 km link of a 0.02 ps/km^{1/2} fiber) approximates the true value τᵣₘₛ with a 100% error. These errors aggregate for multi-span routes (or longer fibers) in a counterintuitive fashion.

An interferometric PMD measurement technique permits one to obtain a frequency average of fiber differential group delay (DGD) values in a single quick scan. A variety of commercially available instruments are used by service providers of an optical network to measure PMD in their installed fiber plants.

### SUMMARY OF THE INVENTION

In accordance with a first aspect of the invention, there is disclosed a methodology for measuring the polarization mode dispersion (PMD) of an optical fiber. The method generally comprises the steps of: estimating a root mean square (rms) differential group delay (DGD) of each of a plurality of fiber sections of the optical fiber by taking measurements τᵢ of DGD values of each fiber section; calculating a multisection DGD value τ_{Σ} according to the formula τ_{Σ}²=Στᵢ²; and determining how much the value τ_{Σ} is likely to differ from a true multisection rms value τ_{Σ}^{rms} by computing a standard deviation σ_{Σ} of τ_{Σ} according to the formula

$${σ}_{Σ}^{2} = \frac{\sum {τ}_{i}^{2} {σ}_{i}^{2}}{\sum {τ}_{i}^{2}}$$

wherein σᵢ is a standard deviation of a measurement τᵢ.

The measurements τᵢ of DGD values of each fiber section may be averaged over a finite bandwidth B over the optical fiber.

The method may further comprise the step of increasing a number of fiber sections over which the measurement τᵢ is taken, thereby reducing the standard deviation σ_{Σ} of τ_{Σ}.

In accordance with a second aspect of the invention, there is disclosed a device for measuring the polarization mode dispersion (PMD) of an optical fiber, comprising: a measurement component for estimating a root mean square (rms) differential group delay (DGD) of each of a plurality of fiber sections of the optical fiber by taking measurements τᵢ of DGD values of each fiber section; a summation module for calculating a multispan DGD value τ_{Σ} according to the formula τ_{Σ}²=Στᵢ²; and an error estimation module for determining how much the value τ_{Σ} is likely to differ from a true multisection rms value τ_{Σ}^{rms} by computing a standard deviation σ_{Σ} of τ_{Σ} according to the formula

$${σ}_{Σ}^{2} = \frac{\sum {τ}_{i}^{2} {σ}_{i}^{2}}{\sum {τ}_{i}^{2}}$$

wherein σᵢ is a standard deviation of a measurement τᵢ.

The measurement component may average the measurements τᵢ of DGD values of each fiber section over a finite bandwidth B over the optical fiber.

In accordance with a third aspect of the invention, there is disclosed a memory medium containing machine readable instructions which, when executed by a processor, enable a device to: estimate a root mean square (rms) differential group delay (DGD) of each of a plurality of fiber sections of the optical fiber by taking measurements τᵢ of DGD values of each fiber section; calculate a multisection DGD value τ_{Σ} according to the formula τ_{Σ}²=Στᵢ²; and determine how much the value τ_{Σ} is likely to differ from a true multisection rms value τ_{Σ}^{rms} by computing a standard deviation σ_{Σ} of τ_{Σ} according to the formula

$${σ}_{Σ}^{2} = \frac{\sum {τ}_{i}^{2} {σ}_{i}^{2}}{\sum {τ}_{i}^{2}}$$

wherein σᵢ is a standard deviation of a measurement τᵢ.

The measurements τᵢ of DGD values of each fiber section may be averaged over a finite bandwidth B over the optical fiber.

These aspects of the invention and further advantages thereof will become apparent to those skilled in the art as the present invention is described with particular reference to the accompanying drawings.

### BRIEF DESCRIPTION OF THE DRAWINGS

FIG. 1 is a schematic conceptually depicting PMD vectors representing a random distribution in magnitude and direction for the respective sections of an optical fiber;

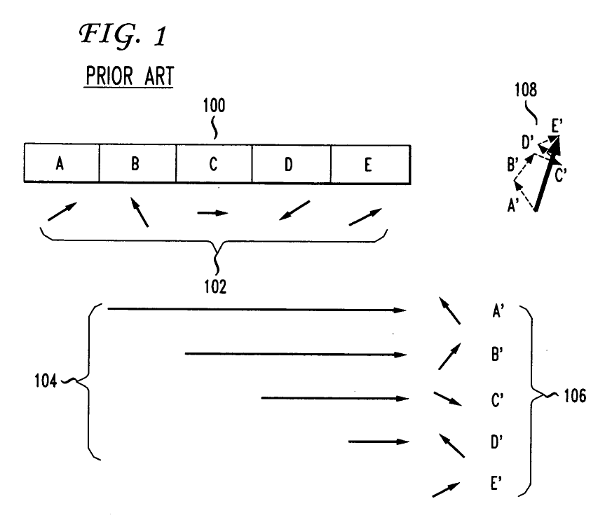

FIG. 2 is a schematic depicting the same fiber conducting an optical signal at a slightly different optical frequency, ω₀+Δω;

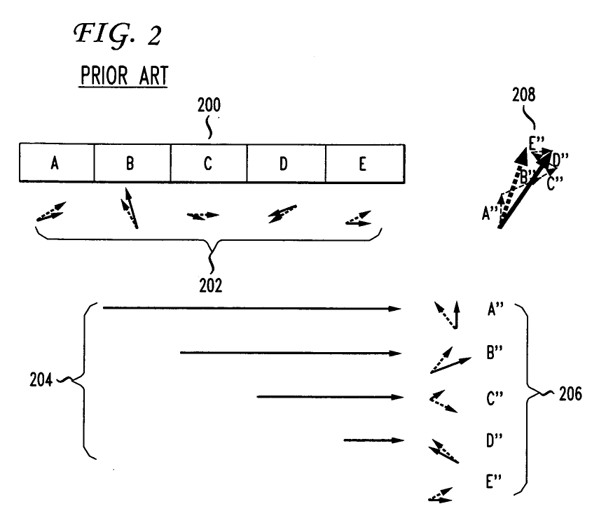

FIG. 3 is a schematic that conceptually depicts an optical medium segregated into a plurality of birefringent sections separated by polarization rotators under system control;

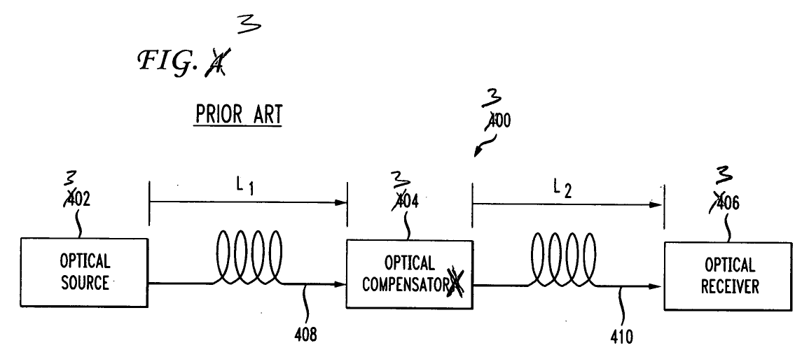

FIG. 4 is a block diagram of an illustrative optical transmission system showing an optical fiber segregated into a plurality of fiber spans connected by an Optical Compensator;

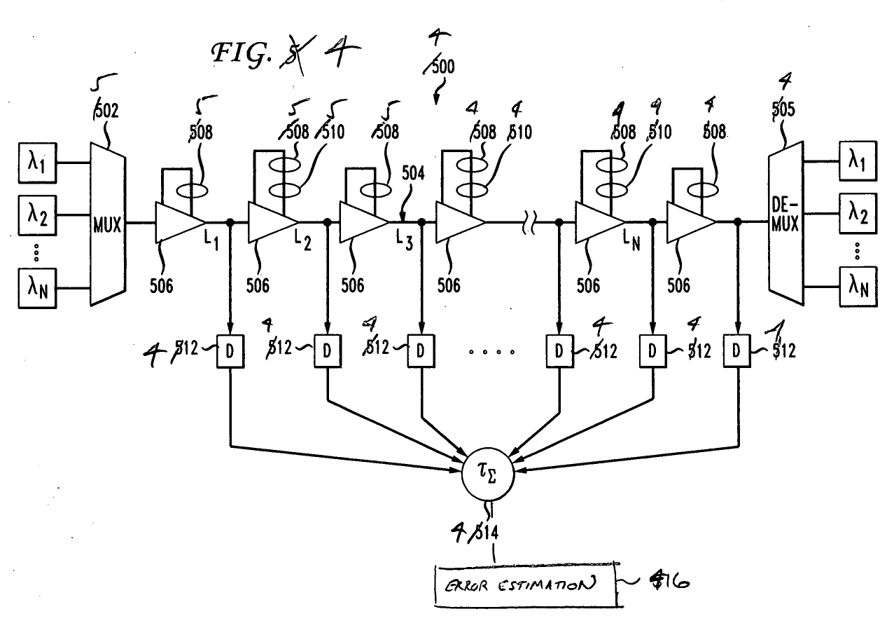

FIG. 5 is a schematic of an exemplary long-haul WDM system in accordance with an aspect of the invention; and

FIG. 6 is a flow chart of an illustrative method in accordance with an aspect of the invention.

### DETAILED DESCRIPTION OF THE INVENTION

Embodiments of the invention will be described with reference to the accompanying drawing figures wherein like numbers represent like elements throughout. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

In accordance with aspects of the invention, a method is disclosed for reducing the uncertainty in the measurement of the root-mean-square average polarization mode dispersion (PMD) of a long fiber by dividing the fiber into a number of shorter sections, with the average PMD of each measured individually. Although the measured PMD in each section will have a greater uncertainty than the measured PMD of the entire fiber, the final calculated result for the entire length has better relative accuracy due to the larger number of measurements and the nature of how PMD values are added for optical fibers segregated into multiple fiber sections.

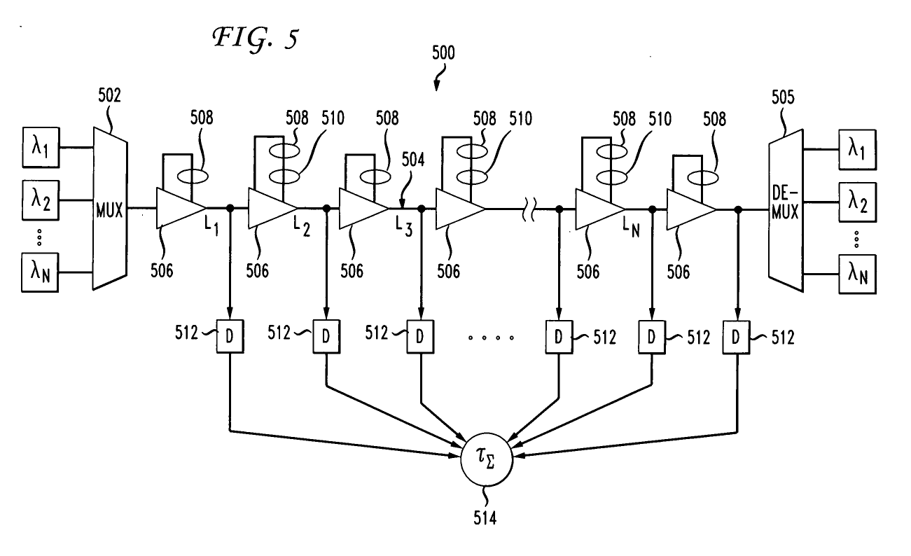

Referring now to FIG. 5, there is depicted an exemplary long-haul WDM system 500 as shown in the '483 patent, which incorporates aspects of the invention, in which a plurality of optical signals having respective wavelengths λ₁, λ₂ . . . λₙ are multiplexed via multiplexer 502 to an optical fiber 504 that has been segregated into a plurality of sections, i.e., fiber sections L₁, L₂, L₃, . . . L_{N}. The multiplexed signals are demultiplexed at 505 as is well known in the art. The demultiplexer 505 may include hardware/software for measuring an error condition such as the total number of bit-errors counted in a received optical signal, and for correcting such errors by utilizing, for example, FEC. A plurality of optical amplifiers 506 are disposed at locations defining the terminating ends of each section L. Such amplifiers are generally placed to restore optical signal amplitudes before they have decayed to a level for which noise levels would corrupt the data. These amplifiers require power and are thus at locations in which other equipment (requiring electrical power) can be placed. A chromatic dispersion compensation module 508 is operably coupled to each amplifier 506 to compensate for the effects of chromatic dispersion in the fiber. In many systems today, such compensators are placed mid-span in a multi-stage optical amplifier. A polarization rotator 510 continuously rotates the optical signal's polarization state. The polarization rotator 510 can be an electro-optic polarization controller that utilizes an electrical drive signal of sufficiently high frequency. The polarization rotator 510 may comprise one or more optical polarization controllers such as, for example, a number of fiber squeezers, a combination of λ/2 and λ/4 optical delay components, or the like. In accordance with the invention, a plurality of detectors 512 are coupled to the individual fiber sections to detect the individual rms DGD values for those sections as described in more detail below.

Using the multi-section configuration as shown in FIG. 5, it can be shown that the absolute uncertainty of the rms DGD value τ_{Σ} of the optical link, which is computed based on the measured rms DGD values of individual sections L₁, L₂, L₃, . . . L_{N} comprising this link, does not accumulate with the number of sections. Thus the relative uncertainty actually reduces with an increasing number of sections for a fixed overall link length.

The parameter, τᵣₘₛ, cannot be measured precisely for recent vintage ultra-low DGD fibers. Experimentally, τᵣₘₛ is approximated by τᵣₘₛ^{B}, i.e., the rms DGD when averaged over finite bandwidth B. The resulting “rms” DGD τᵣₘₛ^{B} is a stochastic variable itself with a known distribution and standard deviation, analytically expressed for a sufficiently large B as σ∝\sqrt{τrms/B}. The lower the τᵣₘₛ of a fiber, the wider the bandwidth of its DGD frequency autocorrelation function is, and thus the bandwidth needed to sample all possible values of τ is wider. Therefore, a wider frequency range B is needed for τᵣₘₛ^{B} to be an accurate estimate of the rms DGD value τᵣₘₛ of low PMD fibers. Typically commercial light sources have a spectrum of no more than 100 nm, with a measured rms DGD value τᵣₘₛ^{B} of 0.2 ps (which corresponds to a 100 km link of a 0.02 ps/km^{1/2} fiber) that approximates the true value τᵣₘₛ with a 100% error.

These errors aggregate for multi-span routes in a counterintuitive fashion. Since the rms DGD value τᵣₘₛ serves as the principal metric describing a fiber system's PMD properties, telecom carriers routinely characterize their installed fiber plants by measuring the rms DGD value of each individual fiber span (span length is about 80 km) in a system, that is, τᵢ^{rms} for the i-th span in the overall link. As discussed above, what is experimentally attainable is not the true rms DGD value of an installed low PMD fiber span τᵢ^{rms}, but rather its statistically uncertain estimate τᵢ. In this connection, if spectrally resolved measurements are utilized for the rms DGD estimation, the estimate's variance can thus be reduced by 50% using statistical properties of the second order PMD. Normally, when many spans are concatenated to form a long route, the multi-span DGD value τ_{Σ} (see FIG. 5, 514) is calculated based on experimentally measured individual span values τᵢ according to the formula: τ_{Σ}²=Στᵢ². Unavoidable measurement ambiguity in each τᵢ causes, in turn, the uncertainty in τ_{Σ}. An important parameter for minimizing the deleterious affects of PMD is how much the computed value τ_{Σ} is likely to differ from the true rms value τ_{Σ}^{rms}.

Mathematically, this can be reformulated by finding the standard deviation σ_{Σ} of an algebraic function τ_{Σ}=τ_{Σ}(τ₁, τ₂, . . . , τ_{N}) for N random variables τᵢ, each of which has a known standard deviation a, (recall that for the fixed measurement bandwidth σᵢ ∝ τᵢ^{1/2}). The variables τᵢ are statistically independent, as they represent different fibers. Thus the following formula can be applied:

σ_{Σ}²=Σ(∂τ_{Σ}/∂τᵢ)²σᵢ²=Στᵢ²σᵢ²/Στᵢ² (1)

It will be appreciated by those skilled in the art, that two asymptotic cases may be used to illustrate the concepts according to the invention. First, consider identical fiber spans, wherein the mean values and standard deviations of measured variables τᵢ are identical among such spans, i.e. for every i, <τᵢ>=τ₀ and σᵢ=σ₀. In this case the expression in Eq. (1) simplifies to:

σ_{Σ}²=Στ₀²σ₀²/Στ₀²=σ₀² (2)

Accordingly, σ_{Σ}=σ₀, and the absolute error with which the calculated τ_{Σ} approximates the true value τ_{Σ}^{rms} does not accumulate with the number of spans N. However since the value τ_{Σ} itself grows as \sqrt{N}(τ_{Σ}=\sqrt{N} τ₀), the relative error becomes smaller for larger values of N.

In addition, if one fiber span's DGD dominates the rest of the fiber spans, then for every i≠k <τᵢ> << <τₖ>, and, correspondingly, <σᵢ> << <σₖ>, it follows from Eq. (1) that σ_{Σ}=σₖ, and:

σ_{Σ}²=Στᵢ²σᵢ²/Στᵢ²≈τₖ²σₖ²/τₖ²=σₖ² (3)

The resulting absolute aggregate error σ_{Σ} is equal to that of the worst span σₖ and is thus independent of the number of spans N.

In the two cases presented above, the absolute uncertainty of the computed value τ_{Σ} is either approximately equal to each span's uncertainty, or to that of the principal contributor of the DGD. More realistic situations in actual applications fall somewhere between the two cases described in the foregoing. Generalizing, it will be appreciated that despite huge relative errors inherent to each τᵢ, the relative error for τ_{Σ} decreases roughly as \sqrt{N} with number of fiber spans N. Accordingly, to obtain a more precise multi-span rms DGD value τ_{Σ}^{rms}, an optical link should be divided into a plurality of shorter spans, with each of these fiber spans measured individually. Although the measurement for each span will be less precise, the final result for τ_{Σ}²=Στᵢ² improves due to the larger number of measurements.

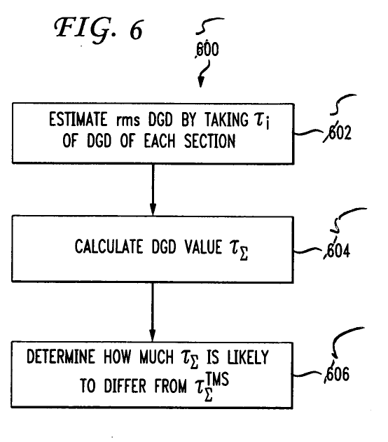

FIG. 6 is a flowchart illustrating an exemplary methodology 600 for practicing the present invention for measuring the polarization mode dispersion (PMD) of an optical fiber. The method generally comprises a first step 602 of estimating a root mean square (rms) differential group delay (DGD) of each of a plurality of fiber sections of the optical fiber by taking measurements τᵢ of DGD values of each fiber section; a second step 604 of calculating a multisection DGD value τ_{Σ} according to the formula τ_{Σ}²=Στᵢ²; and a third step 606 of determining how much the value τ_{Σ} is likely to differ from a true multisection rms value τ_{Σ}^{rms} by computing a standard deviation σ_{Σ} of τ_{Σ} according to the formula

$${σ}_{Σ}^{2} = \frac{\sum {τ}_{i}^{2} {σ}_{i}^{2}}{\sum {τ}_{i}^{2}}$$

wherein σᵢ is a standard deviation of a measurement τᵢ.

The foregoing detailed description is to be understood as being in every respect illustrative and exemplary, but not restrictive, and the scope of the invention disclosed herein is not to be determined from the description of the invention, but rather from the claims as interpreted according to the full breadth permitted by the patent laws. It is to be understood that various modifications will be implemented by those skilled in the art, without departing from the scope and spirit of the invention.

1. A method for measuring the polarization mode dispersion (PMD) of an optical fiber, comprising the steps of:
estimating a root mean square (rms) differential group delay (DGD) of each of a plurality of fiber sections of the optical fiber by taking measurements τᵢ of DGD values of each fiber section;
calculating a multisection DGD value τ_{Σ}according to the formula
τ_{Σ}²=Στᵢ²;
and
determining how much the value τ_{Σ}is likely to differ from a true multisection rms value τ_{Σ}^{rms} by computing a standard deviation σ_{Σ}of τ_{Σ}according to the formula
$${σ}_{Σ}^{2} = \frac{\sum {τ}_{i}^{2} {σ}_{i}^{2}}{\sum {τ}_{i}^{2}}$$
wherein σᵢ is a standard deviation of a measurement τᵢ.

2. The method recited in claim 1, wherein the measurements τᵢ of DGD values of each fiber section are averaged over a finite bandwidth B over the optical fiber.

3. The method recited in claim 1, further comprising the step of:
increasing a number of fiber sections over which the measurement τᵢ is taken, thereby reducing the standard deviation σ₉₃ of τ_{Σ}.

4. A device for measuring the polarization mode dispersion (PMD) of an optical fiber, comprising:
a measurement component that estimates a root mean square (rms) differential group delay (DGD) of each of a plurality of fiber sections of the optical fiber by taking measurements τᵢ of DGD values of each fiber section;
a summation module that calculates a multisection DGD value τ_{Σ}according to the formula
τ_{Σ}²=Στᵢ²;
and
an error estimation module that determines how much the value τ_{Σ}is likely to differ from a true multisection rms value 96 _{Σ}^{rms} by computing a standard deviation σ_{Σ}of τ_{Σ}according to the formula
$${σ}_{Σ}^{2} = \frac{\sum {τ}_{i}^{2} {σ}_{i}^{2}}{\sum {τ}_{i}^{2}}$$
wherein σᵢ is a standard deviation of a measurement τᵢ.

5. The device recited in claim 4, wherein the measurement component averages the measurements τᵢ of DGD values of each fiber section over a finite bandwidth B over the optical fiber.

6-7. (canceled)
